(19) United States
(12) Patent Application Publication
(10) Pub. No.: US 2009/0244454 A1
(43) Pub. Date: Oct. 1, 2009

(54) LIQUID-CRYSTAL DISPLAY DEVICE

(75) Inventors: Jun Watanabe, Minami-ashigara-shi (JP); Ryo Nakamura, Minami-ashigara-shi (JP); Kotaro Yasuda, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/412,732

(22) Filed: Mar. 27, 2009

(30) Foreign Application Priority Data
Mar. 28, 2008 (JP) 2008-085501

(51) Int. Cl. G02F 1/13363; G02B 1/08

(52) U.S. Cl. 349/117; 428/1.31

(57) ABSTRACT

Disclosed is a liquid-crystal display device comprising a liquid-crystal cell that comprises a pair of substrates each having an electrode layer on the facing surface thereof, and a liquid-crystal layer of a liquid-crystal material disposed between the pair of substrates, a driving circuit to impart a driving voltage to the electrode layer, a pair of polarizing elements disposed to sandwich the liquid-crystal cell therebetween, and an optically-anisotropic layer disposed between at least one (first polarizing element) of the pair of polarizing elements and the liquid-crystal cell; wherein retardation in plane at a wavelength of 450 nm, Re(450), of the optically-anisotropic layer, and retardation in plane at a wavelength of 650 nm, Re(650), thereof satisfy the condition, Re(450)/Re(650)<1.25; and a voltage is applied to the electrode layers by the driving circuit, so that the ratio of retardation Re_{b} of the liquid-crystal cell in the black state to the retardation Re_{w} thereof in the white state, Re_{b}/Re_{w}, is equal to or less than 0.015.

### CROSS-REFERENCE TO RELATED APPLICATIONS

This application claims benefit of priority under 35 U.S.C. 119 to Japanese Patent Application No. 2008-085501 filed on Mar. 28, 2008, which is expressly incorporated herein by reference in its entirety.

### BACKGROUND OF THE INVENTION

1. Technical Field

The present invention relates to a liquid-crystal display device, especially to a TN (twisted nematic)-mode liquid-crystal display device.

2. Background Art

A liquid-crystal display device is used not only as the display part of personal computers but also as the display part of TVs, etc. With its applications expanding so, further increase in the contrast ratio of the device is desired, and display characteristics thereof are desired in that the display is darker at the time of black level thereof and is brighter at the time of white level thereof. A liquid-crystal display device may have a problem of viewing angle dependence, which must be solved. In particular, it is desired to reduce the color sift occurring in oblique directions.

For example, JPA No. 2007-2220 discloses a TN-mode liquid-crystal display device in which the color shift is reduced.

### SUMMARY OF THE INVENTION

An object of the invention is to provide a liquid-crystal display device in which the front contrast ratio (the contrast ratio in the direction along the normal line relative to the display panel) is high and the color shift occurring in oblique directions is reduced.

The means for achieving the object is as follows.
[1] A liquid-crystal display device comprising:

a liquid-crystal cell that comprises a pair of substrates each having an electrode layer on the facing surface thereof, and a liquid-crystal layer of a liquid-crystal material disposed between the pair of substrates,

a driving circuit to impart a driving voltage to the electrode layer,

a pair of polarizing elements disposed to sandwich the liquid-crystal cell therebetween, and

an optically-anisotropic layer disposed between at least one (first polarizing element) of the pair of polarizing elements and the liquid-crystal cell;

wherein retardation in plane at a wavelength of 450 nm, Re(450), of the optically-anisotropic layer, and retardation in plane at a wavelength of 650 nm, Re(650), thereof satisfy the following formula (1):

Re(450)/Re(650)<1.25 (1);

and a voltage is applied to the electrode layers by the driving circuit, so that the ratio of retardation Re_{b} of the liquid-crystal cell in the black state to the retardation Re_{w} thereof in the white state, Re_{b}/Re_{w}, is equal to or less than 0.015.
[2] The liquid-crystal display device of according to [1], wherein the voltage stress of the driving circuit is equal to or more than 10 V, and the voltage to be applied between the electrode layers in the black state is equal to or more than 5.5 V.
[3] The liquid-crystal display device according to [1] or [2], wherein the birefringence value, Δn, of the liquid-crystal material is equal to or more than 0.10, and Δnd of the liquid-crystal layer (d is the thickness of the liquid-crystal layer) is equal to or more than 440 nm.
[4] The liquid-crystal display device according to any one of [1] to [3], wherein the optically-anisotropic layer is formed of a composition comprising at least one liquid crystal compound selected from the group represented by formula (I) or (II):

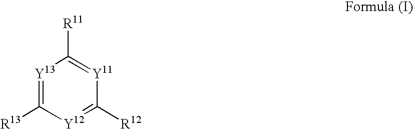

wherein Y¹¹, Y¹² and Y¹³ each independently represents a methine or a nitrogen atom; R¹¹, R¹² and R¹³ each independently represents a following formula (DI-A) or (DI-B):

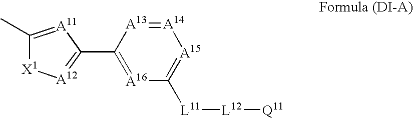

wherein A¹¹, A¹², A¹³, A¹⁴, A¹⁵ and A¹⁶ each independently represents a methine or a nitrogen atom; X¹ represents an oxygen atom, a sulfur atom, a methylene or an imino; L¹¹ represents —O—, —O—CO—, —CO—O—, —O—CO—O—, —S—, —NH—, —SO₂—, —CH₂—, —CH═CH— or —C≡C—; L¹² represents a divalent linking group selected from a group consisting of —O—, —S—, —C(═O)—, —SO₂—, —NH—, —CH₂—, —CH═CH— and —C≡C—, and their any combinations; when the above group is a group having a hydrogen atom, the hydrogen atom may be substituted with a substituent; Q¹¹ independently represents a polymerizable group or a hydrogen atom;

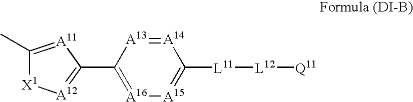

wherein A¹¹, A¹², A¹³, A¹⁴, A¹⁵ and A¹⁶ each independently represents a methine or a nitrogen atom; X¹ represents an oxygen atom, a sulfur atom, a methylene or an imino; L¹¹ represents —O—, —O—CO—, —CO—O—, —O—CO—O—, —S—, —NH—, —SO₂—, —CH₂—, —CH═CH— or —C≡C—; L¹² represents a divalent linking group selected from a group consisting of —O—, —S—, —C(═O)—, —SO₂—, —NH—, —CH₂—, —CH═CH— and —C≡C—, and their any combinations; when the above group is a group having a hydrogen atom, the hydrogen atom may be substituted with a substituent; Q¹¹ independently represents a polymerizable group or a hydrogen atom;

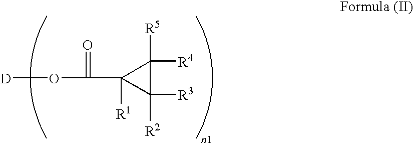

wherein D represents a triphenylene; n1 indicates an integer of from 3 to 6; R¹, R², R³, R⁴ and R⁵ each independently represents a hydrogen atom, a substituted or non-substituted C₁₋₂₀ alkyl group, a substituted or non-substituted C₃₋₂₀ alkenyl group, a substituted or non-substituted C₁₋₂₀ alkoxy group, a substituted or non-substituted C₃₋₂₀ alkenyloxy, a substituted or non-substituted C₆₋₂₀ aryl group, a substituted or non-substituted C₆₋₂₀ aryloxy group, or a substituted or non-substituted C₁₋₂₀ alkoxycarbonyl group.
[5] The liquid-crystal display device according to any one of [1] to [4], which comprises a cellulose acylate film supporting the optically-anisotropic layer, between the optically-anisotropic layer and the first polarizing element.
[6] The liquid-crystal display device according to [5], wherein the cellulose acylate film is adjacent to the first polarizing element and serves also as a protective film for the first polarizing element.
[7] The liquid-crystal display device according to any one of [1] to [6], wherein the liquid-crystal cell is a TN-mode cell.
[8] The liquid-crystal display device according to any one of [1] to [7], wherein the liquid-crystal cell comprises plural pixels as matrices, the pitch between the pixels is smaller than 600 μm, and the size of the liquid-crystal cell is at least 20 inches between the opposite angles.

### BRIEF DESCRIPTION OF THE DRAWINGS

FIG. 1 is a schematic cross-sectional view of one example of the liquid-crystal display device of the invention.

In the drawing, the reference numerals and signs have the following meanings.
10, 11 Polarizing element
12, 13 Film for support
14, 15 Optically-anisotropic layer
LC Liquid-crystal cell
F1, F2 Optically-compensatory film
P1, P2 Polarizing plate

### DETAILED DESCRIPTION OF THE INVENTION

The present invention will be detailed below. Note that any numerical expression in a form of “ . . . to . . . ” in this specification will be used to represent a range including the numerals given before “to” and after “to” as the lower and upper limits, respectively.

In the description, Re(λ) (unit: nm) and Rth(λ) (unit: nm) each indicate retardation in plane and retardation along thickness direction of a sample, a film or the like, at a wavelength λ. Re(λ) is measured by applying a light having a wavelength of λ nm in the normal direction of the film, using KOBRA-21ADH or WR (by Oji Scientific Instruments). The selectivity of the measurement wavelength λ nm may be conducted by a manual exchange of a wavelength-filter, a program conversion of a measurement wavelength value or the like.

When a film to be tested is represented by an uniaxial or biaxial refractive index ellipsoid, then its Rth(λ) is calculate according to the method mentioned below. With the in-plane slow axis (determined by KOBRA 21ADH or WR) taken as the inclination axis (rotation axis) of the film (in case where the film has no slow axis, the rotation axis of the film may be in any in-plane direction of the film), Re(λ) of the film is measured at 6 points in all thereof, up to +50° relative to the normal direction of the film at intervals of 10°, by applying a light having a wavelength of λ nm from the inclined direction of the film.

With the in-plane slow axis from the normal direction taken as the rotation axis thereof, when the film has a zero retardation value at a certain inclination angle, then the symbol of the retardation value of the film at an inclination angle larger than that inclination angle is changed to a negative one, and then applied to KOBRA 21ADH or WR for computation.

With the slow axis taken as the inclination axis (rotation axis) (in case where the film has no slow axis, the rotation axis of the film may be in any in-plane direction of the film), the retardation values of the film are measured in any inclined two directions; and based on the data and the mean refractive index and the inputted film thickness, Rth may be calculated according to the following formulae (10) and (11):

$$\begin{matrix}Re ( θ ) = \\ [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} & ( 10 ) \\ Rth = \{ ( nx + ny ) / 2 - nz \} \times d & ( 11 )\end{matrix}$$

wherein Re(θ) means the retardation value of the film in the direction inclined by an angle θ from the normal direction; nx means the in-plane refractive index of the film in the slow axis direction; ny means the in-plane refractive index of the film in the direction vertical to nx; nz means the refractive index of the film vertical to nx and ny; and d is a thickness of the film.

When the film to be tested can not be represented by a monoaxial or biaxial index ellipsoid, or that is, when the film does not have an optical axis, then its Rth(λ) may be calculated according to the method mentioned below.

With the in-plane slow axis (determined by KOBRA 21ADH or WR) taken as the inclination axis (rotation axis) of the film, Re(λ) of the film is measured at 11 points in all thereof, from −50° to +50° relative to the normal direction of the film at intervals of 10°, by applying a light having a wavelength of λ nm from the inclined direction of the film. Based on the thus-determined retardation data of Re(λ), the mean refractive index and the inputted film thickness, Rth(λ) of the film is calculated with KOBRA 21ADH or WR.

The mean refractive index may be used values described in catalogs for various types of optical films. When the mean refractive index has not known, it may be measured with Abbe refractometer. The mean refractive index for major optical film is described below: cellulose acetate (1.48), cycloolefin polymer (1.52), polycarbonate (1.59), polymethylmethacrylate (1.49), polystyrene (1.59).

The mean refractive index and the film thickness are inputted in KOBRA 21ADH or WR, nx, ny and nz are calculated therewith. From the thus-calculated data of nx, ny and nz, Nz=(nx−nz)/(nx−ny) is further calculated.

In this description, “45°”, “in parallel” or “cross perpendicularly” mean to fall within a range of the precise angle ±less than 5°. The error from the precise angle is preferably less than 4°, more preferably less than 3°. Regarding the numerical range of voltage and others, the error range acceptable in the technical field of liquid-crystal display devices is also acceptable in the invention. Regarding the angle, “+” means a clockwise direction, and “−” means an anticlockwise direction. “Slow axis” means the direction in which the refractive index is the largest. “Visible light region” is from 380 nm to 780 nm. Unless otherwise specifically indicated, the wavelength at which the refractive index is measured herein is λ=550 nm in a visible light region.

The optical properties of the liquid-crystal cell in the invention are determined as follows: A TN-mode liquid-crystal cell has a twisted orientation, in which, therefore, the in-plane slow axis could not be defined and retardation could not be determined according to the above-mentioned method. Therefore, the TN-mode liquid-crystal cell is analyzed according to the method mentioned below, differing from that for films.

Concretely, retardation of the liquid-crystal cell is calculated through analysis of Mueller matrices.

Use of a dual rotate retarder-system polarization analyzer is favorable for analysis of Mueller matrices. In the dual rotate retarder-system polarization analyzer, the analyzer head has a polarization generator unit for generating polarized waves and a polarization analyzer unit for detecting polarized waves, in which both the head units are composed of a wavelength plate and a polarizing element that rotate at high speed (Mueller matrix algorithms, SPIE/VOL. 1746, 1992, pp. 231-246). A method has been proposed for computing parameters for retardation, dichromaticity and polarization cancellation from the Mueller matrices obtained with the above-mentioned analyzer or the like (Decomposition of Mueller matrices, SPIE/VOL. 3120, 1997, pp. 385-396). An apparatus employing a combination of the techniques described in the two references (e.g., Mueller Matrix Polarimeter, by Axometrics) is commercially available; and using the apparatus, retardation of a liquid-crystal cell can be computed.

In this description, “polarizing plate” is meant to include both a long continuous polarizing plate and a polarizing sheet as cut to have a size capable of being incorporated in liquid-crystal displays, unless otherwise specifically indicated. (In this description, “cut” is meant to include “blanking” and “shearing”. In this description, “polarizing film” is differentiated from “polarizing plate”. “Polarizing plate” is meant to indicate a laminate that comprises a “polarizing film” and, as formed on at least one surface thereof, a transparent protective film to protect the polarizing film.

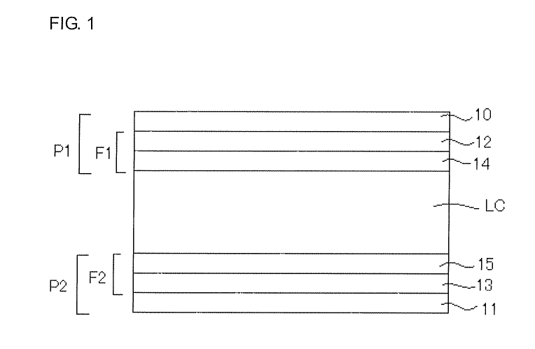

One embodiment of the invention is a TN-mode liquid-crystal display device with twisted orientation. FIG. 1 shows a schematic cross-sectional view of one example of the TN-mode liquid-crystal display device of the invention. In FIG. 1, the relative relation between the constitutive layers in point of their thickness does not always correspond to the relative relation between the constitutive members in point of their thickness in an actual liquid-crystal display device.

The TN-mode liquid-crystal display device shown in FIG. 1 has a liquid-crystal cell LC, a pair of polarizing elements 10 and 11 to be disposed to sandwich the liquid-crystal cell LC, and a pair of optically-compensatory films F1 and F2 to be disposed between the respective polarizing elements 10 and 11 and the liquid-crystal cell LC.

The liquid-crystal cell LC has a pair of facing substrates, and a liquid-crystal layer of a liquid-crystal material put therebetween. On the facing surfaces of the pair of substrates, individually disposed are transparent electrodes (not shown in FIG. 1) that form plural pixels in the facing regions; and for example, on the facing surface of the substrate on the panel side (upper side in FIG. 1), three color filters of red, green and blue corresponding to plural pixel are formed, and a counter electrode layer is formed on them. The electrode layer formed on the inner surface of the substrate on the back side (lower side in FIG. 1) comprises plural pixel electrodes aligned as matrices in the line direction and in the row direction; and the electrode formed on the inner surface of the substrate on the panel side is a one-sheet counter electrode that faces the above-mentioned plural pixel electrodes. However, the invention should not be limited to this constitution.

On the facing surfaces of the pair of electrodes, individually formed are horizontal alignment films processed for alignment in the directions substantially perpendicular to each other. The liquid-crystal layer is a layer filled with a nematic liquid-crystal material having positive dielectric anisotropy, in which the liquid-crystal molecules are defined in their alignment direction around the inner surfaces of the substrates by the horizontal alignment film, and therefore, in no electric field application between the electrodes, the molecules are aligned, as twisted at a twisting angel of substantially 90° between the substrates. On the other hand, in voltage application by a driving circuit between the electrodes in the black state, the liquid-crystal molecules stand up vertically, and are thereby aligned nearly vertically. In that manner, in a normally white mode, the liquid-crystal cell LC is in a twisted alignment state in the white state, and is substantially in a vertical alignment state in the black state.

In general, in a TN-mode liquid-crystal display device, when the voltage in the black state is increased more and more, then the black brightness becomes lower and lower and the front contrast tends to increase more and more; but on the other hand, the color shift in the black state tends to increase more and more (becomes worse and worse). According to the invention, an optically-anisotropic layer satisfying predetermined properties to be mentioned below is used, and a voltage with which the ratio of the retardation Re_{b} of the liquid-crystal cell in the black state to the retardation Re_{w} thereof in the white state, Re_{b}/Re_{w}, is equal to or less than 0.015, is applied by a driving circuit to the electrode layer to drive the device, whereby the display properties of the device are improved both in terms of the front contrast and in terms of the color shift thereof. In terms of the front contrast, Re_{b}/Re_{w} is preferably smaller; and on the other hand, though the lowermost limit thereof is not specifically defined, Re_{b}/Re_{w} is preferably equal to or more than 0.005 in terms of the color shift. In terms of both the two, the device is preferably driven at Re_{b}/Re_{w} falling within a range of from 0.005 to 0.015, more preferably from 0.005 to 0.010.

For driving the device under the above-mentioned condition, preferably, the voltage to be given between the electrode layers in the black state is large. Concretely, a driving voltage of equal to or more than 4.6 V is preferably given between the electrode layer, more preferably of equal to or more than 5.0 V, even more preferably of equal to or more than 5.5 V. Not specifically defined, the uppermost limit of the voltage may be suitably defined within a range for stable driving in accordance with the voltage stress of the driving circuit. In general, the limit is 5.2 V or so. In the invention, a relatively high driving voltage is given to the device, for which, therefore, a driving circuit having a high voltage stress (withstanding voltage) is preferably used. Concretely, a driving circuit having a voltage stress of equal to or more than 10 V is preferably used.

On the other hand, the front contrast may be increased by increasing the white brightness in the white state. The white brightness may be increased by increasing Δnd of the liquid-crystal layer. Δn is birefringence of the liquid-crystal material to form the liquid-crystal layer, and d is the thickness of the liquid-crystal layer. Concretely, Δnd is preferably equal to or more than 420 nm, more preferably equal to or more than 450 nm. For example, using a liquid-crystal material having large Δn makes it possible to increase Δnd of the liquid-crystal layer. When a liquid-crystal material having birefringence Δn of equal to or more than 0.10 is used, then Δnd may be adjusted to the above-mentioned range with the ordinary cell gap d. Δn of the liquid-crystal material to be used in the invention is preferably larger; and though its uppermost limit is not specifically defined in terms of the effect thereof, the uppermost limit of Δn of available liquid-crystal materials is 1.4 or so. Using one or more of nematic liquid crystals having a fluorine atom-containing substituent, nematic liquid crystals having —CN at the terminal, nematic liquid crystals having a double bond or a triple bond and the like produces a liquid-crystal material having Δn of at least 0.10. Commercial products may also e used. For example, “ZLI-1132” (by Merck) is a liquid-crystal material having An of equal to or more than 0.10.

Needless-to-say, And may be increased by increasing the cell gap d; however, in terms of the response speed, the cell gap is preferably smaller. The cell gap may be defined to be from 3.0 to 4.5 μm or so. By increasing the light intensity of the backlight source, the white brightness may also be increased. However, in terms of the power to be consumed, increase in the light intensity of the backlight source is limited.

Between the liquid-crystal cell LC and the pair of polarizer elements 10 and 11, individually disposed are a pair of optically-compensatory films F1 and F2. The optically-compensatory films F1 and F2 both comprise an optically-anisotropic layer 14 or 15 satisfying the following condition (1), and a transparent film 12 or 13 supporting the layer, respectively:

Re(450)/Re(650)<1.25 (1)

Satisfying the above condition (1), the device can reduce the blue shift that may occur in the direction going to the upper side or the lower side in the black state. In the terms of the effect, Re(450)/Re(650) is preferably equal to or less than 1.21, more preferably equal to or less than 1.18. Preferably, the optically-anisotropic layer has regular wavelength dispersion characteristics of retardation in plane, Re, in a visible light region (that is, its Re is larger at a shorter wavelength); and from this viewpoint, Re(450)/Re(650) is preferably more than 1 and less than 1.25.

The optically-anisotropic layer satisfying the above condition (1) may be prepared by using a discotic liquid-crystal compound to be represented by a predetermined formula mentioned below.

The optically-anisotropic layers 14 and 15 are layers formed by fixing discotic liquid crystal molecules in a desired alignment state. For example, a polymerizing discotic liquid crystal is applied to the alignment-processed surface of an alignment film, then aligned in the alignment treatment direction (generally, in the direction of the rubbing axis), and fixed in the alignment state to form the layer. In a hybrid alignment state, in which the tilt angle of the discotic liquid-crystal molecules to the film surface (in this, the tilt angle of discotic face of the discotic liquid-crystal molecules to the film surface) varies in the thickness direction (for example, the tilt angle at the interface to the alignment film surface is the smallest, then increases in the thickness direction, and is the largest at the interface to air), the liquid-crystal molecules may be fixed to form the optically-anisotropic layer.

For the transparent supporting films 12 and 13 of the optically-compensatory films F1 and F2, usable are polymer films. Polymer films of various materials may be used. In case where the films are stuck to the polarizing elements 10 and 11 while kept in contact therewith (optionally via an adhesive layer), thereby serving as protective films, the supporting films 12 and 13 are preferably formed of a material having an affinity for the material of the polarizing elements 10 and 11. From this viewpoint and in consideration of the fact that a polarizing element is generally formed of a polyvinyl alcohol film, preferred is a cellulose acylate film such as triacetyl cellulose. However, this is not limitative, and any others such as norbornene resin films and polycarbonate films are also preferably usable herein. The optical properties of the supporting films 12 and 13 are not specifically defined. In general, preferably, Re(550) of the films is from 0 to 100 nm or so, and Rth(550) thereof is from 50 to 200 nm or so.

As described in the above, the supporting films 12 and 13 of the optically-compensatory films F1 and F2 may also function as the protective films for the polarizing elements 10 and 11, respectively; or that is, the optically-compensatory films F1 and F2 may be stuck to the polarizing elements 10 and 11, thereby constituting a part of the polarizing plates P1 and P2, respectively, to be built in the liquid-crystal display device of the invention.

The liquid-crystal display device shown in FIG. 1 employs a normally white-mode, in which the pair of polarizing elements 10 and 11 are disposed with their absorption axes kept substantially perpendicularly to each other. In general, the polarizing elements have a protective film on both surfaces thereof; however, in FIG. 1, the protective film to be stuck to the outer surface of the polarizing element is omitted. The optical axis relation between the constitutive components may be the same as in ordinary normally-white TN-mode liquid-crystal display devices. One example is as follows: The alignment treatment direction (in general, this is the rubbing axis) of the alignment film formed on the facing surface of the cell substrate on the panel side of the device is in a direction as anticlockwise rotated by 45° from the viewers' side (the upper side in the drawing) in the crosswise direction of the panel of the liquid-crystal display device, and the alignment treatment direction of the alignment film formed on the facing surface of the cell substrate on the back side of the device is in a direction as clockwise rotated by 45° from the viewers' side (the upper side in the drawing) in the crosswise direction of the panel of the liquid-crystal display device. The polarizing element 10 is disposed with its absorption axis kept in parallel to the alignment treatment direction of the alignment film on the display side; and the polarizing element 11 is disposed with its absorption axis kept substantially orthogonal to the absorption axis of the polarizing element 10. The rubbing axis of the alignment film to control the alignment of the optically-anisotropic layer 14 on the panel side is substantially parallel to the alignment treatment direction of the alignment film of the cell substrate on the panel side; and the rubbing axis of the alignment film to control the alignment of the optically-anisotropic layer 15 on the back side is substantially parallel to the alignment treatment direction of the alignment film of the cell substrate on the back side. However, the layer constitution is not limitative; and depending on the material to be used for forming the optically-anisotropic layer and on the type of the alignment film, etc., the device could not always have the layer constitution as above.

Though omitted in FIG. 1, the liquid-crystal display device may optionally have any known components such as a backlight, a front light, a light control film, a brightness control film, a light guide plate, a prism sheet, a light diffuser, a color filter, etc.

The invention is especially suitable for application to large-panel TVs having a large panel size and required to have high-definition display characteristics. Concretely, in one embodiment of the liquid-crystal display device of the invention, the liquid-crystal cell has plural pixels as matrices, the pitch between the pixels is smaller than 600 μm, and the size of the liquid-crystal cell is at least 20 inches between the opposite angles. In this application, in general, the front contrast ratio must be equal to or more than 1000, the color shift between the directions at a polar angle 45° and along the normal line, Δu′ or Δv′, must be equal to or less than 0.06, and the white brightness must be equal to or more than 400 cd/m²; and the liquid-crystal display device of the invention satisfies all these necessary characteristics.

In the above, some embodiments of a TN-mode liquid-crystal display device are described; however, the invention could be effective also in any other modes with no twisting alignment such as VA-mode, OCB-mode, etc.

Various components constituting the liquid-crystal display device of the invention are described in detail hereinunder.

### (Optically-Compensatory Film)

The optically-compensatory film to be used in the invention has an optically-anisotropic layer satisfying the above-mentioned condition (1). As so mentioned in the above, Re(450)/Re(650) of the optically-anisotropic layer is preferably equal to or less than 1.21, more preferably equal to or less than 1.18. Preferably, the optically-anisotropic layer has regular wavelength dispersion characteristics of retardation Re in a visible light region (that is, its Re is larger at a shorter wavelength); and from this viewpoint, Re(450)/Re(650) is preferably more than 1 and less than 1.25.

The optically-anisotropic layer has an optical characteristic capable of compensating birefringence of the liquid-crystal cell. From this viewpoint, Re(550) of the optically-anisotropic layer is preferably from 20 to 60 nm, more preferably from 25 to 55 nm. The optically-anisotropic layer is preferably so planned as to compensate the liquid-crystal compound in the liquid crystal cell in the liquid-crystal display device at the time of black level of display. Regarding the alignment state of the liquid-crystal compound in the liquid-crystal cell, referred to is the description in IDW'00, FMC7-2, pp. 411-414.

In order that the optically-anisotropic layer can satisfy the above-mentioned condition (1), preferably, birefringence of the liquid-crystal compound to be used for forming the layer also has the same wavelength dependence as in the above-mentioned condition (1). From this viewpoint, preferably, the optically anisotropic layer is prepared by using at least one discotic liquid crystal compound selected from the group represented by formula (I) or (II).

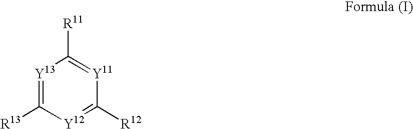

In formula (I), Y¹¹, Y¹² and Y¹³ each independently represents a methine or a nitrogen atom; R¹¹, R¹² and R¹³ each independently represents a following formula (DI-A) or (DI-B).

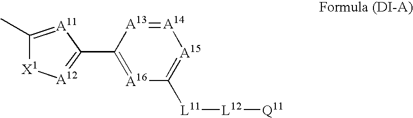

In formula (DI-A), A¹¹, A¹², A¹³, A¹⁴, A¹⁵ and A¹⁶ each independently represents a methine or a nitrogen atom; X¹ represents an oxygen atom, a sulfur atom, a methylene or an imino; L¹¹ represents —O—, —O—CO—, —CO—O—, —O—CO—O—, —S—, —NH—, —SO₂—, —CH₂—, —CH═CH— or —C≡C—; L¹² represents a divalent linking group selected from a group consisting of —O—, —S—, —C(═O)—, —SO₂—, —NH—, —CH₂—, —CH═CH— and —C≡C—, and their any combinations; when the above group is a group having a hydrogen atom, the hydrogen atom may be substituted with a substituent; Q¹¹ independently represents a polymerizable group or a hydrogen atom.

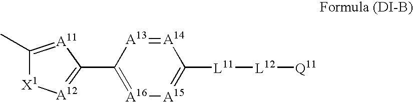

In formula (DI-B), A¹¹, A¹², A¹³, A¹⁴, A¹⁵ and A¹⁶ each independently represents a methine or a nitrogen atom; X¹ represents an oxygen atom, a sulfur atom, a methylene or an imino; L¹¹ represents —O—, —O—CO—, —CO—O—, —O—CO—O—, —S—, —NH—, —SO₂—, —CH₂—, —CH═CH— or —C≡C—; L¹² represents a divalent linking group selected from a group consisting of —O—, —S—, —C(═O)—, —SO₂—, —NH—, —CH₂—, —CH═CH— and —C≡C—, and their any combinations; when the above group is a group having a hydrogen atom, the hydrogen atom may be substituted with a substituent; Q¹¹ independently represents a polymerizable group or a hydrogen atom.

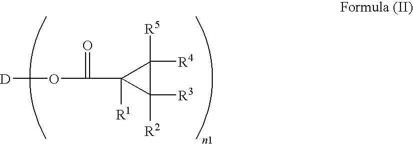

In formula (II), D represents a triphenylene; n1 indicates an integer of from 3 to 6; R¹, R², R³, R⁴ and R⁵ each independently represents a hydrogen atom, a substituted or non-substituted C₁₂₀ alkyl group, a substituted or non-substituted C₃₋₂₀ alkenyl group, a substituted or non-substituted C₁₋₂₀ alkoxy group, a substituted or non-substituted C₃₋₂₀ alkenyloxy, a substituted or non-substituted C₆₋₂₀ aryl group, a substituted or non-substituted C₆₋₂₀ aryloxy group, or a substituted or non-substituted C₁₋₂₀ alkoxycarbonyl group.

The curable liquid crystal composition containing at least one selected from discotic liquid crystal compounds such as those represented by formula (I) or (II) is preferably used for preparing the optically anisotropic layer. Other preferable examples of the compound, which can be used for preparing the layer, include those described in JPA No. 2006-76992, [0052], and those described in JPA No. 2007-2220, [0040]-[0063].

To the liquid-crystal composition for use to form the optically-anisotropic layer, optionally added is a polymer compound such as polymethyl methacrylate, acrylic acid/methacrylic acid copolymer, styrene/maleimide anhydride copolymer, polyvinyl alcohol, poly(N-methylolacrylamide), styrene/vinyltoluene copolymer, chlorosulfonated polyethylene, nitrocellulose, cellulose ester, polyvinyl chloride, chlorinated/vinyl acetate copolymer, polyethylene, polypropylene, polycarbonate, silicone polymer, fluoropolymer and the like, for the purpose of controlling the phase transition temperature, controlling the optical properties of the layer and improving the coatability of the composition. Further, various additives such as a plasticizer, a polymerizable monomer, a chiral agent, a photopolymerization initiator, a sensitizer and the like may also be added to the composition.

The optically-anisotropic layer may be formed by applying a liquid-crystal composition to the surface (preferably the rubbed surface of the alignment film), then processed to be in a desired alignment state, and then cured. For the coating, usable are various methods of a wire bar coating method, an extrusion coating method, a direct gravure coating method, a reverse gravure coating method, a die coating method, etc. The coating amount may be so controlled that the thickness of the optically-anisotropic layer to be formed could be equal to or less than 1 μm. For improving the coatability, a fluorine-containing surfactant is preferably added to the liquid-crystal composition.

Preferably, the liquid-crystal composition is cured through polymerization or crosslinking of the ingredient in the composition. For example, the liquid-crystal composition containing a polymerizing liquid crystal may be irradiated with light such as UV rays to thereby polymerize and cure the layer. In this method, preferably, a photopolymerization initiator is added to the liquid-crystal composition.

The optically-compensatory film for use in the invention preferably has a support to support the optically-anisotropic layer. The support is preferably a glass sheet or a transparent polymer film. Also preferably, the support has a transmittance (at a wavelength of from 400 nm to 700 nm) of equal to or more than 80%, and a haze of equal to or less than 2.0%.

Examples of the major ingredient of the polymer film to be used as a support include cellulose acylates (e.g., cellulose mono-, di- and tri-acylates), norbornene-based polymers and polymethyl methacrylate.

Commercially-available polymers known as a trade name of “Arton®” and “Zeonex®” are also usable herein. Retardation of polymer films may be suitably controlled, if desire. Polymers having a relative small birefringence such as those mentioned in the above are preferred, since their retardation is easy to control and since their films can be stretched uniformly with little stretching unevenness.

For optical compensation of TN-mode liquid-crystal cells, the optically-compensatory film is required to show negative birefringence. For this, preferably, the polymer film used in the optically-compensatory film also shows negative birefringence. Polymers capable of easily expressing birefringence such as known polycarbonates and polysulfones can also be used herein after molecular modification thereof for controlling birefringence expressibility, for example, as in WO00/26705.

As the polymer film, preferred is a cellulose acylate film. Cellulose, as the starting material for the cellulose acylate film, includes cotton linter, kenaf, wood pulp (broadleaf pulp, coniferous pulp), etc.; and any cellulose ester obtained from any type of starting cellulose may be used herein, and as the case may be, two or more different types of cellulose esters may be combined and used.

The cellulose acylate may be prepared by esterifying cellulose. The cellulose acylate is preferably a cellulose ester of a carboxylic acid having from 2 to 22 carbon atoms in total. The acyl group having from 2 to 22 carbon atoms that the cellulose acylate has may be an aliphatic acyl group or an aromatic acyl group, and is not specifically defined. They include, for example, cellulose alkylcarbonyl esters, alkenylcarbonyl esters, cycloalkylcarbonyl esters, or aromatic carbonyl esters, aromatic alkylcarbonyl esters, etc.; and they may further have a substituted group. Preferred acyl groups include acetyl, propionyl, butanol, heptanoyl, hexanoyl, octanoyl, cyclohexanecarbonyl, adamantanecarbonyl, phenylacetyl, benzoyl, naphthylcarbonyl, (meth)acryloyl and cinnamoyl groups. Of those acyl groups, more preferred are acetyl, propionyl, butanoyl, pentanoyl, hexanoyl, cyclohexanecarbonyl, (meth)acryloyl and phenylacetyl groups.

Methods of producing cellulose acylates are described in detail in Hatsumei Kyokai Disclosure Bulletin No. 2001-1745 (published on Mar. 15, 2001 by Hatsumei Kyokai) p. 9, and the description therein may be referred to herein.

Preferably, the polymer film is subjected to a surface-treatment. Examples of the surface-treatment include corona discharge treatment, glow discharge treatment, flame treatment, acid treatment, alkali treatment (saponification) and UV irradiation treatment. When the polymer film is a cellulose acylate film, preferably, it is subjected to a saponification as a surface treatment.

The optically-compensatory film to be used in the invention may have an alignment film between the optically-anisotropic layer and the support. The alignment film acts for formation of the optically-anisotropic layer. Preferably, the alignment film is formed by rubbing the surface of a layer of a polymer such as polyvinyl alcohol or the like.

Also preferably, the alignment film is a crosslinked polymer layer. It may be formed of a polymer crosslinkable by itself, or may be formed of a combination of a crosslinkable polymer and a crosslinking agent. For example, a functional group-having polymer may be inter-crosslinked by exposure to light or heat or by pH change; or a highly-reactive crosslinking agent may be added to a crosslinkable polymer so as to introduce the crosslinking agent-derived bonding group into the polymer to thereby crosslink the polymer. Examples of the polymer usable in forming the alignment film include polymers such as polymethyl methacrylate, acrylic acid/methacrylic acid copolymer, styrene/maleinimide copolymer, polyvinyl alcohol, modified polyvinyl alcohol, poly(N-methylolacrylamide), styrene/vinyltoluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, caboxymethyl cellulose, polyethylene, polypropylene, polycarbonate, etc; and compounds such as silane coupling agent.

Preferred examples of the polymer include water-soluble polymers such as poly(N-methylolacrylamide), carboxymethyl cellulose, gelatin, polyvinyl alcohol, modified polyvinyl alcohol, etc.; more preferred are gelatin, polyvinyl alcohol and modified polyvinyl alcohol; and even more preferred are polyvinyl alcohol and modified polyvinyl alcohol.

Of the above-mentioned polymers, preferred are polyvinyl alcohol and modified polyvinyl alcohol. The polyvinyl alcohol has generally, for example, a degree of saponification of from 70 to 100%, preferably from 80 to 100%, more preferably from 85 to 95%.

The degree of polymerization of the polymer is preferably within a range of from 100 to 3,000.

The surface of the alignment film is rubbed. The rubbing treatment may be attained in any known method of using, for example, a rubbing roll or the like.

As so mentioned in the above, the optically-compensatory film may be stuck to a polarizing element to produce a polarizer for use in the liquid-crystal display device of the invention.

The polarizing element is not specifically defined. Various polarizing elements may be used in the invention. Preferred is a coated polarizing element typically by Optiva Inc., or a polarizing element comprising a binder, and iodine or a dichroic dye.

The polarizing element may be produced by stretching the binder in the machine direction (MD) of the binder and then coloring it with iodine or a dichroic dye.

To the surface of the polarizing element opposite to the surface thereof to which the optically-compensatory film has been stuck, a protective film is preferably stuck. Examples of the protective film may be the same as those of the polymer film usable as the support of the optically-compensatory film.

When the polarizing element is stuck to the optically-compensatory film and to the protective film, an adhesive may be used. For example, a polyvinyl alcohol resin (including polyvinyl alcohol modified with an acetoacetyl group, a sulfonic acid group, a carboxyl group or an oxyalkylene group) or an aqueous solution of a boron compound may be used as the adhesive. Of those, preferred is a polyvinyl alcohol resin.

The thickness of the adhesive layer is preferably within a range of from 0.01 to 10 μm as a dry thickness thereof, more preferably within a range of from 0.05 to 5 μm.

In case where the polarizer of the invention is on the viewing side of the liquid-crystal display device of the invention, preferably, an antireflection layer is disposed on the viewing side of the polarizer in the device, in which the antireflection layer may serve also as the protective layer on the viewing side of the polarizing element.

From the viewpoint of preventing the viewing angle-dependent color shift in the liquid-crystal display device, the internal haze of the antireflection layer therein is preferably equal to or more than 50%. Preferred examples of the constitution are described in, for example, JPA Nos. 2001-33783, 2001-343646, and 2002-328228.

### EXAMPLES

Examples of the invention are described below, to which, however, the invention should not limited.

### <Production of Polarizer>

### (Production of Cellulose Acylate Film)

The ingredients mentioned below were put into a mixing tank and stirred therein under heat to dissolve the ingredients, thereby preparing a cellulose acylate solution.

### (Formulation of Cellulose Acylate Solution)

| | |
|---|---|
| Cellulose acetate | 100 mas. pts. |
| having a degree of acetylation of from 60.7 to 61.1% | |
| Triphenyl phosphate (plasticizer) | 7.8 mas. pts. |
| Biphenyldiphenyl phosphate (plasticizer) | 3.9 mas. pts. |
| Methylene chloride (first solvent) | 336 mas. pts. |
| Methanol (second solvent) | 29 mas. pts. |
| 1-Butanol (third solvent) | 11 mas. pts. |

Into another mixing tank, 16 parts by mass of a retardation enhancer mentioned below, 92 parts by mass of methylene chloride and 8 parts by mass of methanol were put, and stirred under heat to prepare a retardation enhancer solution. Next, 31 parts by mass of the retardation enhancer solution was added to 474 parts by mass of the above-mentioned cellulose acylate solution and well stirred to prepared a dope.

### Retardation Enhancer:

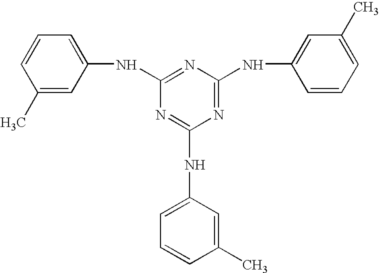

The resulting dope was cast on the band, using a band caster. After the film surface temperature on the band reached 40° C., this was dried with hot air at 70° C. for 1 minute, then with hot air at 140° C. for 10 minutes, and thereafter peeled away from the band to give a cellulose acylate film having a residual solvent amount of 0.3% by mass (thickness: 80 μm).

Retardation in plane, Re, and retardation along thickness direction, Rth, of the thus-produced cellulose acylate film were determined; and Re was 8 nm and Rth was 91 nm.

### (Alkali Saponification)

The cellulose acylate film produced in the above was dipped in a solution of potassium hydroxide (2.0 mol/L) (25° C.) for 2 minutes, then neutralized with sulfuric acid, washed with pure water and dried. The surface energy of the film was determined according to a contact angle method, and was 63 mN/m.

### (Production of Alignment Film for Optically-Anisotropic Layer)

To the cellulose acylate film, an alignment film coating liquid having the formulation mentioned below was applied in an amount of 28 mL/m², using a wire bar coater #16. This was dried with hot air at 60° C. for 60 seconds and then with hot air at 90° C. for 150 seconds.

### (Formulation of Alignment Film Coating Liquid)

| | | |
|---|---|---|
| Modified polyvinyl alcohol mentioned below | 20 | mas. pts. |
| Water | 360 | mas. pts. |
| Methanol | 120 | mas. pts. |
| Glutaraldehyde (crosslinking agent) | 1.0 | mas. pt. |

Modified Polyvinyl Alcohol:

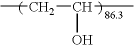

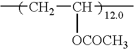

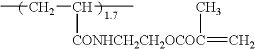

### (Rubbing Treatment)

The above cellulose acylate film was conveyed at a speed of 20 m/min, a rubbing roll (having a diameter of 300 mm) was set thereon so as to rub the surface of the layer. The rubbing roll was rotated at 650 rpm to rub the surface of the layer formed on the cellulose acylate film, thereby forming an alignment film thereon. The contact length with the rubbing roll was controlled to be 18 mm.

### (Production of Optically-Compensatory Film A)

An optically-compensatory film coating liquid A having the formulation mentioned below was prepared.

| | | |
|---|---|---|
| D-112 (JP-A 2007-76992) | 45 | mas. pts. |
| Fluorine-containing polymer compound | 0.27 | mas. pts. |
| (FP-1) mentioned below | | |
| Photopolymerization initiator | 1.35 | mas. pts. |
| (Irgacure 907, by Ciba-Geigy) | | |
| Sensitizer (Kayacure DETX, by Nippon Kayaku) | 0.45 | mas. pts. |
| Methyl ethyl ketone | 190 | mas. pts. |

FP-1:

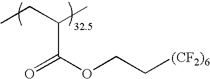

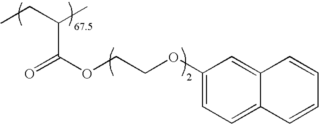

The coating liquid A was continuously applied to the rubbed surface of the alignment film of the wind-up film being unrolled and conveyed at a speed of 20 m/min, using a wire bar #3.0 rotating in the same direction as the film traveling direction at the same speed as that of the film. During the process of continuously heating the film from room temperature to 100° C., the solvent was dried away, and then in a drying zone at 110° C., the film was heated for about 120 seconds to thereby align molecules of the discotic liquid-crystal compound. Next, this was conveyed to a drying zone at 90° C., and irradiated with UV rays at an illuminance of 600 mW for 4 seconds, using a UV irradiator (UV lamp: output 160 W/cm, emission length 1.6 m), thereby crosslinking the film to fix molecules of the discotic liquid-crystal compound in the alignment state. Next, this was left cooled to room temperature, and winded up as a cylindrically form to give an optically-compensatory film roll. This was used as Optically-Compensatory Film A.

### (Determination of Properties of Optically-Anisotropic Layer of Optically-Compensatory Film A)

The optically-anisotropic layer was separately formed on a different glass substrate according to the above-mentioned method. Retardation of the thus-formed thin film, at a wavelength of 450 nm and 650 nm, was measured. From the found data, Re(450)/Re(650) was calculated, and was 1.15.

The thickness of the optically-anisotropic layer was measured with an interference film thickness gauge (reflective film thickness monitor: FE-3000, by Otsuka Electronics). As a result, the thickness was 0.8 μm.

### (Production of Optically-Compensatory Films B to G)

A coating liquid having the formulation mentioned below was continuously applied onto the alignment film of the above-mentioned roll film being unrolled and conveyed at a speed of 20 m/min, using a wire bar #3.0 rotating in the same direction as the film traveling direction at the same speed as that of the film. During the process of continuously heating the film from room temperature to 100° C., the solvent was dried away, and then in a drying zone at 110° C., the film was heated for about 120 seconds to thereby align molecules of the discotic liquid-crystal compound. Next, this was conveyed to a drying zone at 90° C., and irradiated with UV rays at an illuminance of 600 mW for 4 seconds, using a UV irradiator (UV lamp: output 160 W/cm, emission length 1.6 m), thereby crosslinking the film to fix molecules of the discotic liquid-crystal compound in the alignment state. Next, this was left cooled to room temperature, and rolled up as a cylindrical form.

An optically-anisotropic layer coating liquid having the formulation mentioned below was prepared.

| | | |
|---|---|---|
| Discotic compound (1) shown in the Table | 40.5 | mas. pts. |
| mentioned below | | |
| Discotic compound (2) shown in the Table | 4.5 | mas. pts. |
| mentioned below | | |
| Fluorine-containing polymer compound (FP-1) | 0.27 | mas. pts. |
| Fluorine-containing polymer compound (FP-2) | 0.10 | mas. pts. |
| Photopolymerization initiator | 1.35 | mas. pts. |
| (Irgacure 907, by Ciba-Geigy) | | |
| Sensitizer (Kayacure DETX, by Nippon Kayaku) | 0.45 | mas. pts. |
| Methyl ethyl ketone | 190 | mas. pts. |

FP-2:

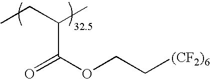

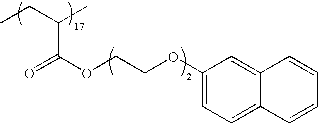

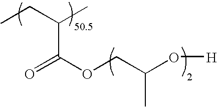

Optically-Compensatory Films B to G were produced in the same manner as above, for which, however, the formulation of the constitutive ingredients was changed and the coating condition was also changed as in the following Table. The other ingredients not indicated in the following Table were the same as those in the above.

TABLE 1

| Film | Discotic compound (1) | Discotic compound (2) |
|---|---|---|
| B | D-112 described in JPA No. | Discotic Compound (A) shown |
| | 2006-76992 | below |
| C | D-304 described in JPA No. | Discotic Compound (A) shown |
| | 2006-76992 | below |
| D | D-225 described in JPA No. | Discotic Compound (A) shown |
| | 2007-2220 | below |
| E | D-227 described in JPA No. | Discotic Compound (A) shown |
| | 2007-2220 | below |
| F | D-10 described in JPA No. | Discotic Compound (A) shown |
| | 2007-2220 | below |
| G | D-286 described in JPA No. | Discotic Compound (A) shown |
| | 2007-2220 | below |

Discotic Compound (A) described in JPA No. 2001-166144
as Compound 44

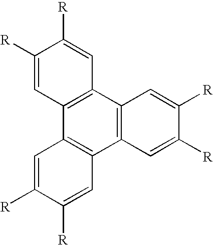

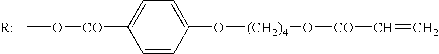

D-112 described in JPA No. 2006-76992

D-112

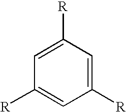

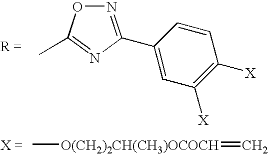

D-304 described in JPA No. 2006-76992

D-304

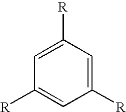

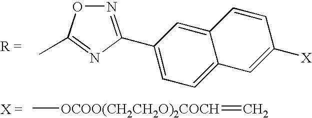

D-225 described in JPA No. 2007-2220

D-225

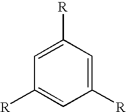

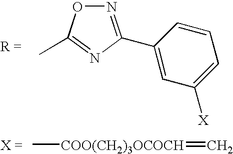

D-227 described in JPA No. 2007-2220

D-227

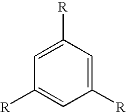

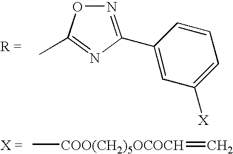

D-10 described in JPA No. 2007-2220

D-10

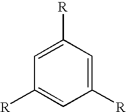

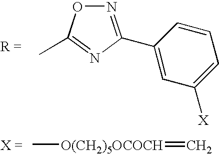

D-286 described in JPA No. 2007-2220

D-286

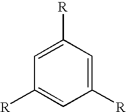

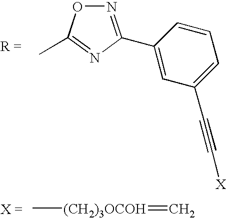

### (Production of Optically-Compensatory Film H)

An optically-anisotropic layer coating liquid H having the formulation mentioned below was prepared.

| | | |
|---|---|---|
| Discotic liquid-crystal compound (DL-1) | 95.00 | mas. pts. |
| Ethyleneoxide-modified trimethylolpropane triacrylate | 5.00 | mas. pts. |
| (V#360, by Osaka Organic Chemistry) | | |
| Cellulose acetate butyrate (CAB555-1, by | 2.00 | mas. pts. |
| Eastman Chemical) | | |
| Photopolymerization initiator (Irgacure 907, | 3.00 | mas. pts. |
| by Ciba-Geigy) | | |
| Sensitizer (Kayacure DETX, by Nippon Kayaku) | 1.00 | mas. pt. |
| Fluoroaliphatic group-having copolymer | 0.22 | mas. pts. |
| (Megafac F780, by Dai-Nippon Ink) | | |
| Methyl ethyl ketone | 225 | mas. pts. |

DL-1:

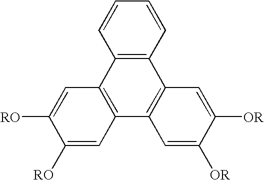

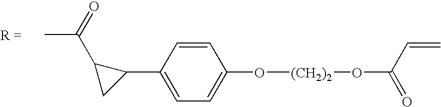

The coating liquid H was continuously applied to the rubbed surface of the alignment film of the wind-up film being unrolled and conveyed at a speed of 20 m/min, using a wire bar #3.4 rotating in the same direction as the film traveling direction at the same speed as that of the film. During the process of continuously heating the film from room temperature to 100° C., the solvent was dried away, and then in a drying zone at 135° C., the film was heated for about 120 seconds to thereby align molecules of the discotic liquid-crystal compound. Next, this was conveyed to a drying zone at 100° C., and irradiated with UV rays at an illuminance of 600 mW for 4 seconds, using a UV irradiator (UV lamp: output 160 W/cm, emission length 1.6 m), thereby crosslinking the film to fix molecules of the discotic liquid-crystal compound in the alignment state. Next, this was left cooled to room temperature, and rolled up as a cylindrically form to give an optically-compensatory film roll. This was used as Optically-Compensatory Film H.

### (Production of Optically-Compensatory Film J)

An optically-anisotropic layer coating liquid J having the formulation mentioned below was prepared.

| | | |
|---|---|---|
| Liquid-crystal compound | 91.00 | mas. pts. |
| (Discotic Compound (A) shown above) | | |
| Ethyleneoxide-modified trimethylolpropane triacrylate | 9.00 | mas. pts. |
| (V#360, by Osaka Organic Chemistry) | | |
| Cellulose acetate butyrate (CAB531-1, by | 1.00 | mas. pt. |
| Eastman Chemical) | | |
| Photopolymerization initiator (Irgacure 907, by Ciba- | 0.50 | mas. pts. |
| Geigy) | | |
| Sensitizer (Kayacure DETX, by Nippon Kayaku) | 1.00 | mas. pt. |
| Methyl ethyl ketone | 225 | mas. pts. |

The coating liquid J was continuously applied to the rubbed surface of the alignment film of the wind-up film being unrolled and conveyed at a speed of 20 m/min, using a wire bar #3.6 rotating in the same direction as the film traveling direction at the same speed as that of the film. During the process of continuously heating the film from room temperature to 100° C., the solvent was dried away, and then in a drying zone at 135° C., the film was heated for about 120 seconds to thereby align the discotic liquid-crystal compound. Next, this was conveyed to a drying zone at 100° C., and irradiated with UV rays at an illuminance of 600 mW for 4 seconds, using a UV irradiator (UV lamp: output 160 W/cm, emission length 1.6 m), thereby crosslinking the film to fix molecules of the discotic liquid-crystal compound in the alignment state. Next, this was left cooled to room temperature, and rolled up as a cylindrically form to give an optically-compensatory film roll. This was used as Optically-Compensatory Film J.

### (Production of Polarizing Plate A)

A polyvinyl alcohol (PVA) film having a thickness of 80 μm was dipped for coloring in an aqueous iodine solution having an iodine concentration of 0.05% by mass, at 30° C. for 60 seconds, and then while dipped in an aqueous boric acid solution having a boric acid concentration of 4% by mass for 60 seconds, this was stretched in the machine direction by 5 times the original length, and thereafter dried at 50° C. for 4 minutes to give a polarizing film (polarizing element) having a thickness of 20 μm.

### (Saponification Step)

Optically-Compensatory Film A was dipped in an aqueous sodium hydroxide solution (1.5 mol/L) at 55° C., and then fully washed with water to remove sodium hydroxide. Next, this was dipped in an aqueous solution of dilute sulfuric acid (0.005 mol/L) at 35° C. for 1 minute, and then dipped in water to sufficiently remove the aqueous solution of dilute sulfuric acid. Finally, the sample was fully dried at 120° C.

Optically-Compensatory Film A thus saponified in the manner as above was combined with a commercially-available cellulose acetate film that had been saponified also in the same manner as above and stuck together via the above-mentioned polarizing film, using a polyvinyl alcohol adhesive, thereby giving a polarizing plate, Polarizing Plate A. The commercially-available cellulose acetate film is Fujitac TF80UL (by FUJIFILM).

In this, the polarizing film, the protective film on one side of the polarizing film, and the optically-compensatory film on the other side thereof were all wind-up films, and the machine direction of each wind-up film was in parallel to that of the other wind-up films, and they were stuck together continuously. Accordingly, the machine direction of the wind-up optical film (the casting direction of the film) was in parallel to the absorption axis of the polarizing element.

### (Production of Polarizing Plates B to H and J)

Polarizing Plates B, C, D and E were produced in the same manner as that for the method for producing Polarizing Plate A, for which, however, Optically-Compensatory Films B, C, D and E were used in place of Optically-Compensatory Film A.

### Example 1

A polyimide alignment film was formed on a glass substrate having a transparent electrode, and aligned by rubbing. The substrate was combined with another glass substrate processed for the same treatment with the alignment-treated surfaces of the two facing each other, via a spacer having a uniform particle size of 2.8 μm with a liquid-crystal cell gap d being 4.2 μm, and a liquid-crystal composition having Δn of 0.1396 (ZLI1132, by Merck) was dropwise introduced into the space between the substrates and sealed up, thereby producing a liquid-crystal cell. An means birefringence of the liquid-crystal material. To both surfaces of the thus-produced liquid-crystal cell, above-mentioned Polarizing Plate A was stuck via an adhesive in such a manner that the absorption axis of Polarizing Plate A could be in the rubbing direction of the upper and lower substrates of the liquid-crystal cell, and then a backlight was fitted to it to construct a liquid-crystal display device, Liquid Crystal Display Device A.

ZLI-1132, Merck's commercial product:

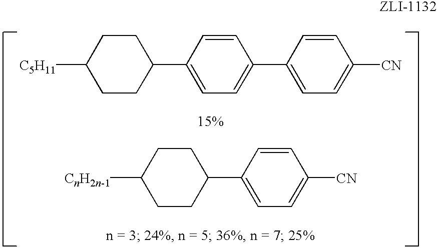

A 60 Hz rectangular wave voltage was applied to the thus-produced liquid-crystal display device. This is a normally white mode with 0.5 V in the white state and 5.1 V in the black state. As the driving circuit, used was a commercial driver for VA-mode TVs having a voltage stress of 16 V.

Retardation Re_{b} and Re_{w} of the liquid-crystal cell in the black state and in the white state, according to the method mentioned in the above, and Re_{b}/Re_{w} was calculated. The results are shown in the Table mentioned below.

Using “EZ-Contrast 160D” (by ELDIM) as a tester, the front contrast ratio, that is, transmittance ratio (white state/black state) was determined. The samples having a contrast ratio of equal to or more than 1200 are “OO, good”; those having a contrast ratio of from 800 to less than 1200 are “O, average”; and those having a contrast ratio of less than 800 are “x, not good”.

Using a color brightness meter “BM-5A” (by Topcon), the color shift at a chromaticity v′ along the direction going to the upper side was determined. The samples in which the color shift was small are “O, average”; those in which the color shift was almost unrecognizable are “\textcircled{∘}, good”; and those in which the color shift was great are “x, not good”. “A” means that the color shift was recognizable in some degree but was smaller than “x”; and “xx” means that the color shift was remarkable to be on a level recognizable even at a polar angle of 150 or less.

In addition, the white brightness was also determined. The samples having a white brightness of equal to or more than 450 cd/m² are “\textcircled{∘}, good”; those having a white brightness of from 400 cd/m² to less than 450 cd/m² are “O, average”. The results are shown in the Table mentioned below.

### Examples 2 to 12, and Comparative Examples 1 to 5

Liquid-crystal display devices were produced in the same manner as in Example 1, for which, however, the polarizing plate used and the driving voltage and others were changed as in the Table mentioned below; and the devices were tested and evaluated in the same manner as above. The results are shown in the following Table.

In the Table, Liquid-Crystal Cell A is the liquid-crystal cell used in Example 1. Liquid-Crystal Cell B is one produced in the same manner as in Example 1, for which, however, the liquid-crystal material having Δn of 0.10 taken out of a commercial liquid-crystal display (AL2216W, by ACER) was used.

TABLE

| | | | | | | Optically- | | | | |
|---|---|---|---|---|---|---|---|---|---|---|
| | | | | | | Compensatory | | | | |
| | Liquid Crystal Cell A | | | | | Film | | Evaluation | | |
| | | | Δnd | Voltage | Re, b/ | | Re450/ | Front | Color | Brightness |
| | No. | Δn | (nm) | in B *1 | Re, w | No. | Re650 | Contrast | shift | in W*2 |
| Example 1 | A | 0.14 | 420 | 5.1 V | 1.2% | A | 1.18 | ◯ | ◯ | ◯ |
| Example 2 | A | 0.14 | 420 | 5.1 V | 1.2% | D | 1.16 | ◯ | ◯ | ◯ |
| Example 3 | B | 0.10 | 420 | 5.1 V | 1.2% | E | 1.15 | ◯ | ⊚ | ◯ |
| Example 4 | B | 0.10 | 420 | 5.7 V | 0.9% | E | 1.15 | ⊚ | ⊚ | ◯ |
| Example 5 | B | 0.10 | 420 | 5.7 V | 0.9% | B | 1.19 | ⊚ | ◯ | ◯ |
| Example 6 | B | 0.10 | 420 | 5.7 V | 0.9% | C | 1.21 | ⊚ | ◯ | ◯ |
| Example 7 | B | 0.10 | 420 | 5.7 V | 0.9% | F | 1.17 | ⊚ | ⊚ | ◯ |
| Example 8 | A | 0.14 | 420 | 5.7 V | 0.9% | G | 1.19 | ⊚ | ◯ | ◯ |
| Example 9 | A | 0.14 | 420 | 5.7 V | 0.9% | H | 1.19 | ⊚ | ◯ | ◯ |
| Example 10 | B | 0.10 | 420 | 5.1 V | 1.3% | E | 1.15 | ◯ | ⊚ | ◯ |
| Example 11 | A | 0.14 | 450 | 5.2 V | 1.2% | D | 1.15 | ◯ | ◯ | ⊚ |
| Example 12 | A | 0.14 | 450 | 5.7 V | 0.9% | E | 1.15 | ⊚ | ◯ | ⊚ |
| Comparative | A | 0.14 | 420 | 4.5 V | 1.9% | A | 1.18 | X | ◯ | ◯ |
| Example 1 | | | | | | | | | | |
| Comparative | B | 0.10 | 420 | 4.5 V | 1.9% | J | 1.27 | X | Δ | ◯ |
| Example 2 | | | | | | | | | | |
| Comparative | B | 0.10 | 420 | 5.1 V | 1.2% | J | 1.27 | ◯ | X | ◯ |
| Example 3 | | | | | | | | | | |
| Comparative | A | 0.14 | 420 | 5.1 V | 1.3% | J | 1.27 | ◯ | X | ◯ |
| Example 4 | | | | | | | | | | |
| Comparative | A | 0.14 | 450 | 5.2 V | 1.2% | J | 1.27 | | XX | ⊚ |
| Example 5 | | | | | | | | | | |

*1 Voltage to be applied in the black state
*2Brightness in the white state

From the results shown in the above table, It can be understood that the liquid-crystal display devices of Examples of the invention all have a high front contrast and the color shift in these in oblique directions is small.

What is claimed is:

1. A liquid-crystal display device comprising:
a liquid-crystal cell that comprises a pair of substrates each having an electrode layer on the facing surface thereof, and a liquid-crystal layer of a liquid-crystal material disposed between the pair of substrates,
a driving circuit to impart a driving voltage to the electrode layer,
a pair of polarizing elements disposed to sandwich the liquid-crystal cell therebetween, and
an optically-anisotropic layer disposed between at least one (first polarizing element) of the pair of polarizing elements and the liquid-crystal cell;
wherein retardation in plane at a wavelength of 450 nm, Re(450), of the optically-anisotropic layer, and retardation in plane at a wavelength of 650 nm, Re(650), thereof satisfy the following formula (1):
Re(450)/Re(650)<1.25 (1);
and a voltage is applied to the electrode layers by the driving circuit, so that the ratio of retardation Re_{b} of the liquid-crystal cell in the black state to the retardation Re_{w} thereof in the white state, Re_{b}/Re_{w}, is equal to or less than 0.015.

2. The liquid-crystal display device of claim 1, wherein the voltage stress of the driving circuit is equal to or more than 10 V, and the voltage to be applied between the electrode layers in the black state is equal to or more than 5.5 V.

3. The liquid-crystal display device of claim 1, wherein the birefringence value, Δn, of the liquid-crystal material is equal to or more than 0.10, and Δnd of the liquid-crystal layer (d is the thickness of the liquid-crystal layer) is equal to or more than 440 nm.

4. The liquid-crystal display device of claim 1, wherein the optically-anisotropic layer is formed of a composition comprising at least one liquid crystal compound selected from the group represented by formula (I) or (II): 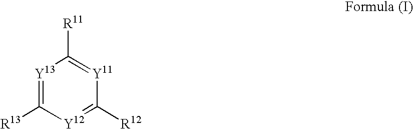
wherein Y¹¹, Y¹² and Y¹³ each independently represents a methine or a nitrogen atom; R¹¹, R¹² and R¹³ each independently represents a following formula (DI-A) or (DI-B): 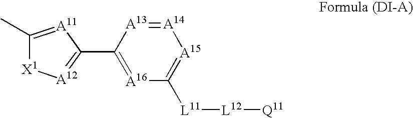
wherein A¹¹, A¹², A¹³, A¹⁴, A¹⁵ and A¹⁶ each independently represents a methine or a nitrogen atom; X¹ represents an oxygen atom, a sulfur atom, a methylene or an imino; L¹¹ represents —O—, —O—CO—, —CO—O—, —O—CO—O—, —S—, —NH—, —SO₂—, —CH₂—, —CH═CH— or —C≡C—; L¹² represents a divalent linking group selected from a group consisting of —O—, —S—, —C(═O)—, —SO₂—, —NH—, —CH₂—, —CH═CH— and —C≡C—, and their any combinations; when the above group is a group having a hydrogen atom, the hydrogen atom may be substituted with a substituent; Q¹¹ independently represents a polymerizable group or a hydrogen atom; 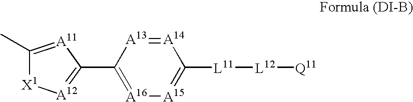
wherein A¹¹, A¹², A¹³ A¹⁴, A¹⁵ and A¹⁶ each independently represents a methine or a nitrogen atom; X¹ represents an oxygen atom, a sulfur atom, a methylene or an imino; L¹¹ represents —O—, —O—CO—, —CO—O—, —O—CO—O—, —S—, —NH—, —SO₂—, —CH₂—, —CH═CH— or —C≡C—; L¹² represents a divalent linking group selected from a group consisting of —O—, —S—, —C(═O)—, —SO₂—, —NH—, —CH₂—, —CH═CH— and —C≡C—, and their any combinations; when the above group is a group having a hydrogen atom, the hydrogen atom may be substituted with a substituent; Q¹¹ independently represents a polymerizable group or a hydrogen atom; 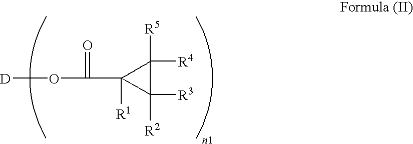
wherein D represents a triphenylene; n1 indicates an integer of from 3 to 6; R¹, R², R³, R⁴ and R⁵ each independently represents a hydrogen atom, a substituted or non-substituted C₁₋₂₀ alkyl group, a substituted or non-substituted C₃₋₂₀ alkenyl group, a substituted or non-substituted C₁₋₂₀ alkoxy group, a substituted or non-substituted C₃₋₂₀ alkenyloxy, a substituted or non-substituted C₆₋₂₀ aryl group, a substituted or non-substituted C₆₋₂₀ aryloxy group, or a substituted or non-substituted C₁₋₂₀ alkoxycarbonyl group.

5. The liquid-crystal display device of claim 1, which comprises a cellulose acylate film supporting the optically-anisotropic layer, between the optically-anisotropic layer and the first polarizing element.

6. The liquid-crystal display device of claim 4, wherein the cellulose acylate film is adjacent to the first polarizing element and serves also as a protective film for the first polarizing element.

7. The liquid-crystal display device of claim 1, wherein the liquid-crystal cell is a TN-mode cell.

8. The liquid-crystal display device of claim 1, wherein the liquid-crystal cell comprises plural pixels as matrices, the pitch between the pixels is smaller than 600 μm, and the size of the liquid-crystal cell is at least 20 inches between the opposite angles.
